(19) United States
(12) Patent Application Publication
(10) Pub. No.: US 2010/0251211 A1
(43) Pub. Date: Sep. 30, 2010

(54) GENERATING AND USING CODE-BASED DIAGRAMS

(75) Inventors: Suhail Dutta, Kirkland, WA (US); Joao Pedro Silva, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/411,399

(22) Filed: Mar. 26, 2009

(51) Int. Cl. G06F 9/44; G06F 3/048; G06N 5/02

(52) U.S. Cl. 717/109; 715/765; 706/54; 707/E17.055

(57) ABSTRACT

Aspects of the subject matter described herein relate to generating and using code-based diagrams. In aspects, analysis components analyze computer code to determine entities and interactions between the entities of the computer code. The entities and interactions or a subset thereof are displayed as a diagram. By interacting with a user interface, a user may instruct a tool to combine entities together and hide interactions between the entities, expand collapsed entities, zoom in on entities that contain other entities, zoom out on entities contained within other entities, move entities and interactions to other diagrams, navigate between diagrams, or perform other actions to generate or use diagrams related to computer code.

### BACKGROUND

Maintaining and understanding large programs is challenging. Large programs may have millions of lines of code that implement hundreds of objects that interact with each other. Making changes to the code without properly understanding this interaction may cause the code to function in unintended ways.

In response, companies have created tools that generate graphical representations of interactions within a program. Unfortunately, these tools are not well suited for dealing with large programs.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to generating and using code-based diagrams. In aspects, analysis components analyze computer code to determine entities and interactions between the entities of the computer code. The entities and interactions or a subset thereof are displayed as a diagram. By interacting with a user interface, a user may instruct a tool to combine entities together and hide interactions between the entities, expand collapsed entities, zoom in on entities that contain other entities, zoom out on entities contained within other entities, move entities and interactions to other diagrams, navigate between diagrams, or perform other actions to generate or use diagrams related to computer code.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” is to be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a diagram that illustrates an exemplary sequence of interactions between entities in accordance with aspects of the subject matter described herein;

FIG. 3 is a diagram that illustrates chunks of a diagram in accordance with aspects of the subject matter described herein;

FIG. 4-5 are diagrams corresponding to the diagram 205 of FIG. 2 in which certain interactions and/or entities have been hidden in accordance with aspects of the subject matter described herein;

FIG. 6 is a block diagram that represents an apparatus configured in accordance with aspects of the subject matter described herein; and

FIGS. 7-8 are flow diagrams that generally represent actions that may occur in accordance with aspects of the subject matter described herein.

### DETAILED DESCRIPTION

### Definitions

As used herein, the term “includes” and its variants are to be read as open-ended terms that mean “includes, but is not limited to.” The term “or” is to be read as “and/or” unless the context clearly dictates otherwise. Other definitions, explicit and implicit, may be included below.

### Exemplary Operating Environment

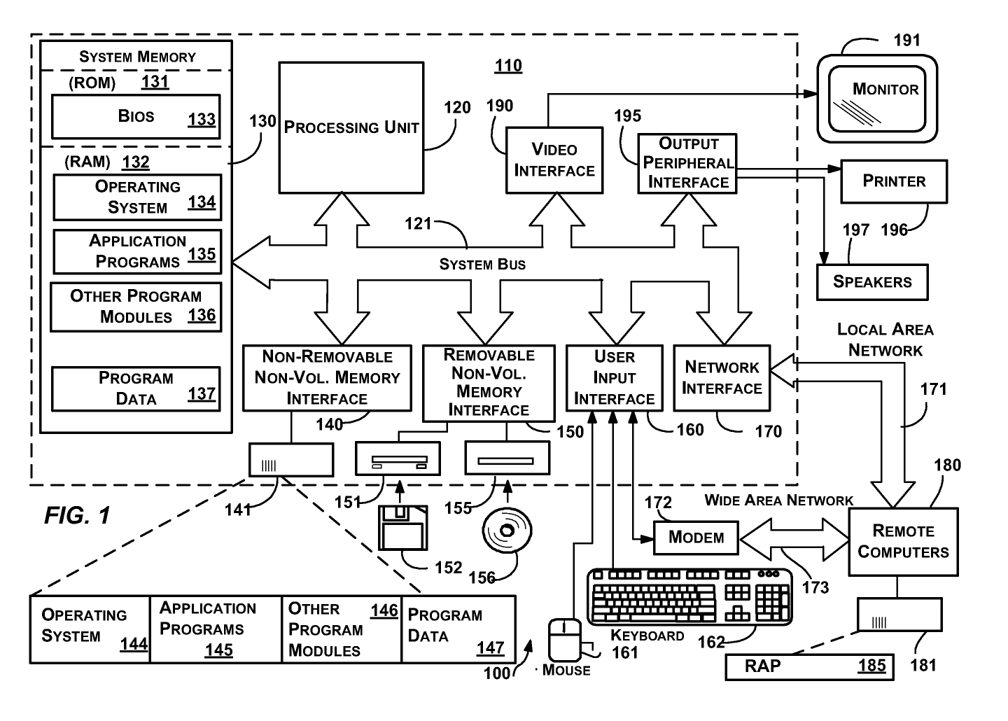

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, or configurations that may be suitable for use with aspects of the subject matter described herein comprise personal computers, server computers, hand-held or laptop devices, multiprocessor systems, microcontroller-based systems, set top boxes, programmable consumer electronics, network PCs, minicomputers, mainframe computers, personal digital assistants (PDAs), gaming devices, printers, appliances including set-top, media center, or other appliances, automobile-embedded or attached computing devices, other mobile devices, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include magnetic tape cassettes, flash memory cards, digital versatile discs, other optical discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies.

A user may enter commands and information into the computer 20 through input devices such as a keyboard 162 and pointing device 161, commonly referred to as a mouse, trackball, or touch pad. Other input devices (not shown) may include a microphone, joystick, game pad, satellite dish, scanner, a touch-sensitive screen, a writing tablet, or the like. These and other input devices are often connected to the processing unit 120 through a user input interface 160 that is coupled to the system bus, but may be connected by other interface and bus structures, such as a parallel port, game port or a universal serial bus (USB).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Architectural Diagrams

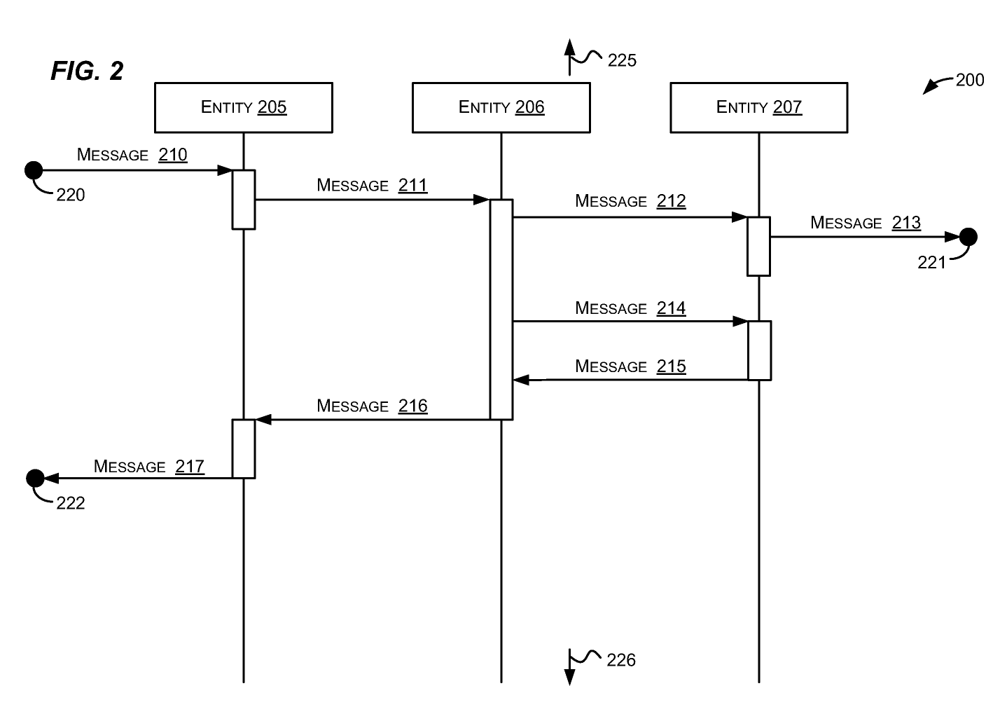

As mentioned previously, maintaining and understanding large programs is challenging. FIG. 2 is a diagram that illustrates an exemplary sequence of interactions between entities in accordance with aspects of the subject matter described herein. Although aspects of the subject matter described herein are sometimes described herein with reference to exemplary sequence diagrams, there is no intention that the teachings herein may only be applied to sequence diagrams. Indeed, in some embodiments, the teachings described herein may also be applied to class diagrams, database schemas, and other software elements and interactions that may be modeled using a modeling language without departing from the spirit or scope of aspects of the subject matter described herein.

Turning to FIG. 2, the diagram 200 illustrates entities 205-207 and messages 210-217. Time flows from top to bottom meaning that an event (e.g., a message) that occurs below another event occurs after the other event.

Each of the entities 205-207 may comprise a collection of one or more objects, namespaces, components, classes, processes, or the like that correspond to various elements of a program. The term “process” may include one or more traditional processes, threads, other elements that perform tasks, and the like. For example, the entity 205 may comprise a customer object, the entity 206 may comprise an employee object, and the entity 207 may comprise a system object.

The vertical lines beneath the entities 205-207 are sometimes referred to as a lifeline. Where a lifeline exists, the entity corresponding to the lifeline exists. Where a lifeline stops, the entity corresponding to the lifeline no longer exists in the scope of a particular interaction, but may still exist in the scope of other interactions.

In one embodiment, an interaction comprises a message, function call, invocation, or the like between entities. In other embodiments, an interaction may comprise a relationship between entities such as inheritance, an association, a dependency, or the like. Unless the context clearly indicates otherwise, as used herein, the term “between” may involve two or more entities. When more than two entities are involved in an interaction, the term between is to be read as “among.”

The messages 210-217 comprise messages that are sent from one entity to another. A message may include a request to perform one or more actions, a notification that an event has occurred, information that responds to a previous message, and the like. A message may be labeled with some informative text (e.g., the name of a method, function, or otherwise) to give an indication of the purposes of the message.

The points 220-222 represent entities and interactions that are outside the diagram 200. The diagram 200 may be generated by analyzing code. Code includes instructions and related data that indicate actions a computer is to take. Code may include source code, executable code, intermediate language code, data including metadata and other data, resources, variables, definitions, relationships, associations, or any other information that may be used to indicate actions a computer is to take.

As will be readily understood by those skilled in the art, a diagram for anything but the smallest of programs may easily involve dozens of entities and many messages passing between these entities. Showing these entities and messages may be difficult or impossible to do without reducing the size of the visual elements or increasing the area in which the entities and messages are shown.

In accordance with aspects of the subject matter described herein, various actions may be taken to make the viewing of a diagram more manageable. For example, pre- and post-generation filters may be applied to generating a diagram. Some examples of pre-generation filters include call depth filtering, namespace filtering, solution filtering, project filtering, assembly filtering, class filtering, method filtering, category filtering, and the like.

A solution may include one or more projects where each project may include one or more classes. A category may include, for example, accessor (e.g., get a property) methods, setters (e.g., set a property) methods, system calls, event invocations, certain types of assignment statements (e.g., assigning a variable to a constant value), other categories, and the like.

Some examples of post-generation filtering include hiding and showing individual elements or groups of elements, collapsing and expanding groups of elements, and the like. Post-generation filtering is described in more detail below.

To generate the diagram 200, in one example, a user may open source code and select (e.g., right click on) a method of a class. The user may then be presented with a dialog box that allows the user to indicate that a diagram is to be generated. The dialog box may allow the user to enter a maximum call depth and one or more filters. After the user has entered the information or accepted default settings, the user may indicate that a diagram is desired. After the user makes this indication, an analysis tool may analyze code and generate a diagram (e.g., the diagram 200).

In analyzing code, the analysis tool may determine that the resulting diagram needs to be split up into various chunks. This determination may be made based on a threshold for the number of entities in the resulting diagram, the number of messages, or by some other heuristic. As one example of a heuristic, a diagram may be split based on projects within a solution, where a solution may include multiple projects. Entities and interactions within one project may be included on the same diagram. When an interaction crosses a project boundary, a new diagram may be created and linked to the existing diagram.

As another example, a user may specify a number of diagrams, and the analysis tool may split entities and interactions amongst the diagrams so as to distribute entities and interactions amongst the diagrams.

As another example, if the analysis tool finds more than a threshold of interactions (e.g., more than X calls) with a particular entity (e.g., a method), the analysis tool may create a separate diagram for the entity and link to it from the main diagram. As another example, a pattern of interactions between entities may be used to determine whether to create a separate diagram.

As another example, code semantics may be used to create multiple diagrams. For example, if a particular piece of code has multiple paths (e.g., due to an ‘if-else’ or other conditional statement), then the analysis tool may produce one diagram for each of the multiple paths and link them together. As another example, if a particular piece of code has a mainline scenario and multiple exception scenarios, the analysis tool may produce a diagram for the mainline scenario and move the exception cases to a different diagram.

The exemplary heuristics above are not intended to be all-inclusive or exhaustive of the possible heuristics that may be employed. Indeed, based on the teachings herein, those skilled in the art may recognize many other heuristics that may be used without departing from the spirit or scope of aspects of the subject matter described herein.

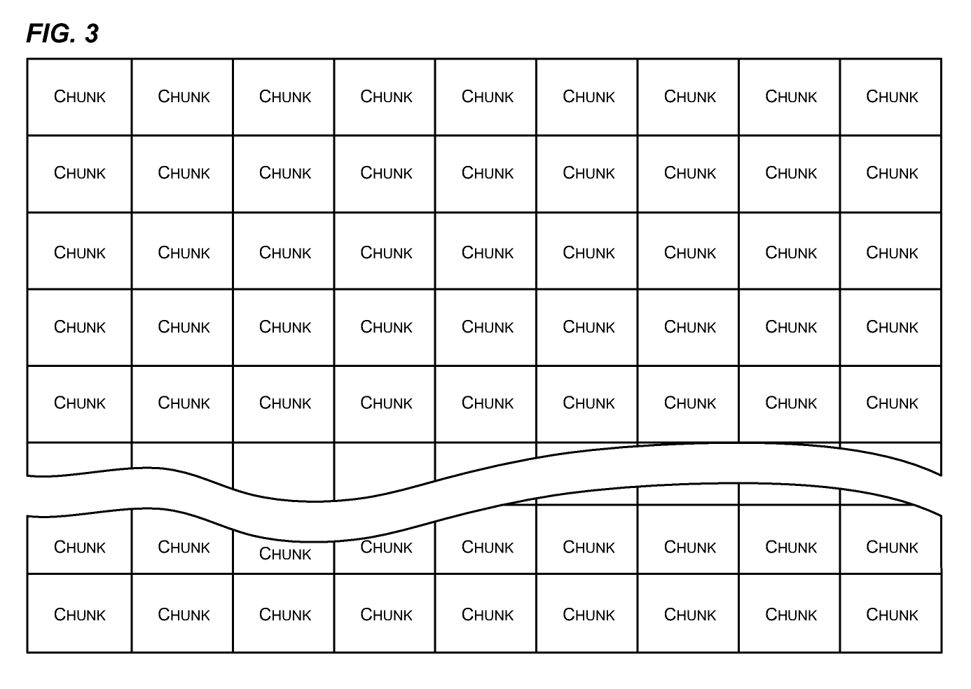

FIG. 3 is a diagram that illustrates chunks of a diagram in accordance with aspects of the subject matter described herein. Each chunk may correspond to a diagram of entities and interactions such as the diagram 205 of FIG. 2. Together, the chunks may represent a partial or complete diagram based on whatever filters have been specified.

As one example, to navigate to a chunk on the right or left of a currently displayed chunk, a user may select a point (e.g., one of the points 220-222 of FIG. 2), scroll bar, page element, or some other graphical element. To navigate to a chunk below or above a currently displayed chunk, a user may select an arrow (e.g., one of the arrows 225-226), scroll bar, page element, or some other graphic element. In another example, a user may press hot keys to navigate between chunks. In one embodiment, the chunks may be accessible via a book control that allows the user to move to a next or a previous page or to a higher or lower page, where the pages correspond to the chunks of FIG. 3.

Although the chunks are illustrated as being the same size, in other embodiments, they may be of varying sizes. In addition, although as illustrated there are the same number of chunks in each column and row, in other embodiments, there may be different numbers of chunks in each column and row and the number of chunks per column or row may more or less than those illustrated in FIG. 3.

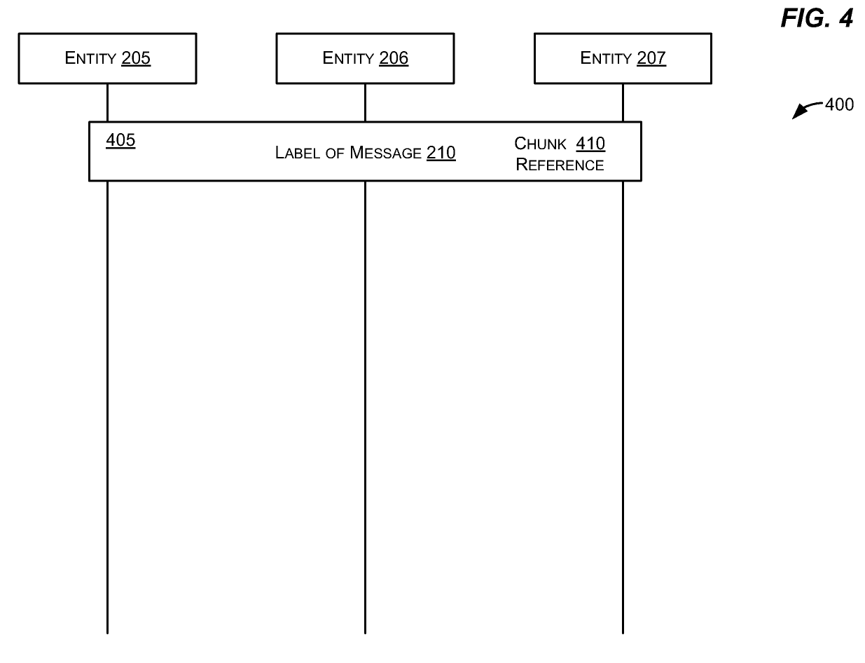

Chunks may be generated in response to user input. For example, referring to FIG. 2, a user may select the message 210 and indicate that the message 210 and interactions to the right of the message be moved to a separate diagram. An example of a resulting diagram created in response to an instruction by the user is illustrated in FIG. 4 which is a diagram corresponding to the diagram 205 of FIG. 2 in which certain interactions have been hidden in accordance with aspects of the subject matter described herein.

Turning to FIG. 4, the diagram 400 has a box 405 that includes the label of the message 210 (of FIG. 2) together with a chunk reference 410. The box 405 represents the interactions between entities illustrated in FIG. 2. In response to a user selecting the chunk reference 410, the analysis tool may display the diagram 200 of FIG. 2.

Returning to FIG. 2, an analysis tool may generate the diagram 200 in multiple passes. During a first pass, the analysis tool may generate interactions between high level entities. For example, the analysis tool may determine the namespaces involved in the code and may generate a diagram that illustrates interactions between entities based on the namespaces. For example, the entity 205 may represent a customer namespace, the entity 206 may represent an employee namespace, and the entity 207 may represent a system namespace.

When the user selects a particular entity, the user may be given the option of “drilling down” into that entity. This option of drilling down may be displayed as a link or other graphical element that the user may select to obtain more details regarding the entity.

In one embodiment, the analysis tool may perform just-in-time analysis of the entities and interactions such that the analysis tool may wait until the analysis is needed before the analysis tool performs the analysis. For example, the analysis tool may wait to analyze some entities and interactions until a user “drills down” into a diagram. In another embodiment, the analysis tool may perform analysis in the background as the analysis tool waits for the user to provide additional instructions.

In one embodiment, the analysis tool may provide the user with an option of “zooming in” or “zooming out” from a particular level of detail about a diagram. Zooming in may provide an action similar to “drilling down” while zooming out may revert to a higher level diagram.

When the user selects the element, an entity corresponding to the element may be expanded into its sub entities. For example, selecting a link associated with the entity 207 may cause the analysis tool to show interactions between assemblies included in the entity 207. Selecting an assembly may cause the analysis tool to show interactions between classes of the assembly. Selecting a class may cause the analysis tool to show interactions between methods of the class.

The examples of entities and sub entities mentioned above are not intended to be all-inclusive or exhaustive of the types of entities and sub entities that may be used with aspects of the subject matter described herein.

To speed analysis and to be able to provide a high level view of interactions between high level entities, the analysis tool may generate diagrams first for the high level entities and then begin generating details for the lower level entities contained within the high level entities. The analysis tool may generate details for lower level entities in the background and may use a generation algorithm in which it generates details for entities that the user is likely to view next (e.g., based on locality to entities the user is currently viewing).

The analysis tool may provide a graphical element that allows the user to switch between levels of detail so that when the user is viewing a particular entity, the user can switch to a diagram that includes lower level entities contained within the entity or to a diagram that includes a higher level entity that includes the entity.

Returning to FIG. 2, when the user selects one of the points 220-222, the user may be presented with a dialog box that allows the user to indicate whether another entity is to be added to the diagram or whether another diagram is to be generated and linked to the point. If the user indicates that another entity is to be added, the analysis tool may then analyze the code to display interactions included by adding the entity associated with the selected point. If the user indicates that another diagram is to be generated, the analysis tool may analyze the code to create a diagram that includes interactions associated with the selected point and place these interactions in a diagram that may be navigated to by selecting the point.

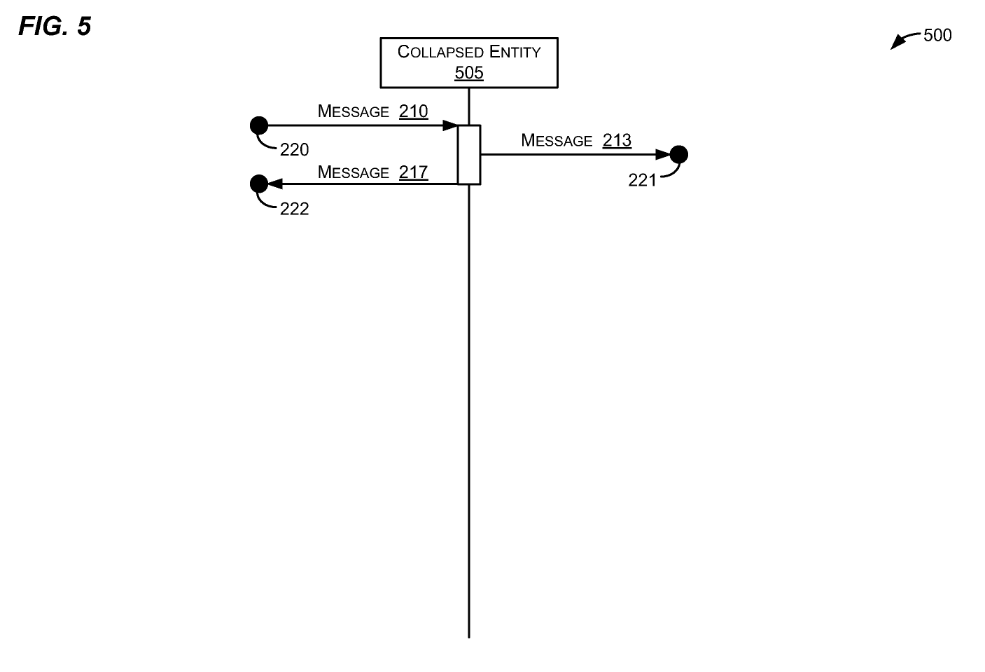

In accordance with aspects of the subject matter described herein, a user may select one or more entities and indicate that the interactions associated with the entities are to be collapsed. For example, if the user were to select the entities 205-207 and collapse these entities, the diagram 500 illustrated in FIG. 5 may result. Note that in the diagram 500 that the messages between the entities 205-207 have been removed while the messages that come or go from the points 220-221 remain. The collapsed entity 505 includes the entities 205-207 of FIG. 2.

To view the details of a collapsed entity, a user may also be able to indicate that the collapsed entity is to be expanded. Alternatively, or in addition, a user may be provided with a link that allows the user to view a chunk that includes the interactions associated with the entities in the collapsed entity.

The analysis tool may allow the user to view code associated with a particular entity, message, method declaration, method call, class, namespace, project, control flow statement, and the like. For example, the user may indicate that the user desires to see a method call by double clicking on a message illustrated in a diagram. In response, the analysis tool may display the code block that includes the method call and highlight or otherwise indicate the method call.

The analysis tool may also have the capability of responding to changes made to the code by regenerating only those portions of diagrams that are affected by the changes to the code. As will be recognized by those skilled in the art, this may greatly reduce the amount of time needed to generate a diagram.

Although the diagrams described above include various entities and interactions between the entities, it will be recognized that computer code may include more, fewer, or a different entities and interactions and others without departing from the spirit or scope of aspects of the subject matter described herein.

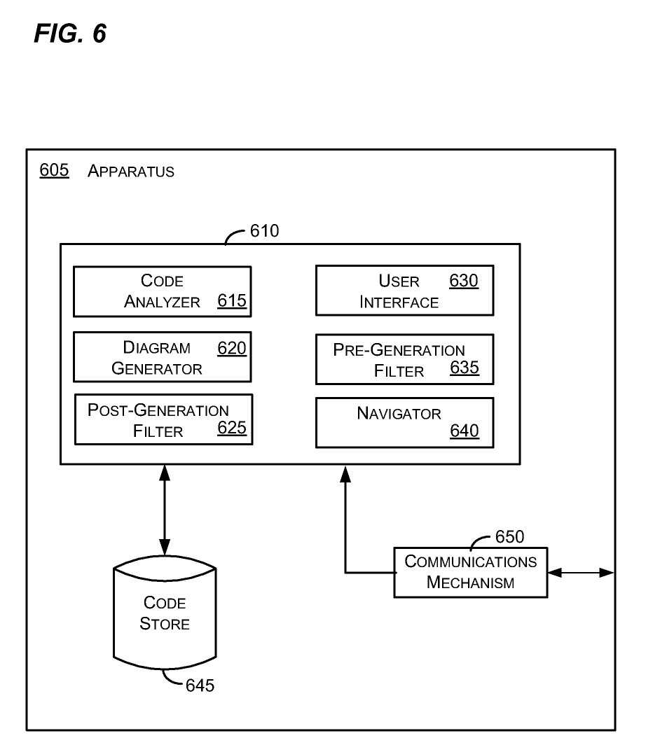

FIG. 6 is a block diagram that represents an apparatus configured in accordance with aspects of the subject matter described herein. The components illustrated in FIG. 6 are exemplary and are not meant to be all-inclusive of components that may be needed or included. In other embodiments, the components and/or functions described in conjunction with FIG. 3 may be included in other components (shown or not shown) or placed in subcomponents without departing from the spirit or scope of aspects of the subject matter described herein. In some embodiments, the components and/or functions described in conjunction with FIG. 6 may be distributed across multiple devices.

Turning to FIG. 6, the apparatus 605 may include architectural components 610, a code store 645, a communications mechanism 650, and other components (not shown). The apparatus 605 may be implemented as a special or general purpose computer (e.g., as the computer 110 of FIG. 1).

The architectural components 610 may include a code analyzer 615, a diagram generator 620, a post-generation filter 625, a user interface 630, a pre-generation filter 635, a navigator 640, and other components (not shown). In other embodiments, there may be more than one of the components listed above. For example, in one embodiment, there may be a plurality of code analyzers 615. In another embodiment, there may be a plurality of post-generation filters 625 or pre-generation filters 635. In another embodiment, there may be a plurality several of the components listed above.

As used herein, the term component is to be read to include all or a portion of a device, one or more software components executing on one or more devices, some combination of one or more software components and one or more devices, and the like. In one embodiment, one or more of the components above may be implemented as one or more processes.

The communications mechanism 650 allows the apparatus 605 to communicate with other external components, if any, involved in analyzing or outputting the results of analyzing. For example, if multiple nodes work together in analyzing entities and relationships, the apparatus 605 may communicate with the other nodes via the communications mechanism 650. The communications mechanism 650 may be a network interface or adapter 170, modem 172, or any other mechanism for establishing communications as described in conjunction with FIG. 1.

The code store 645 (hereinafter sometimes referred to as “store 645”) is any storage media capable of storing data. The term data is to be read broadly to include anything that may be stored on a computer storage medium. Some examples of data include code, program state, other data, and the like. The store 645 may comprise a file system, database, volatile memory such as RAM, other storage, some combination of the above, and the like and may be distributed across multiple devices. The store 645 may be external, internal, or include components that are both internal and external to the apparatus 605.

In particular, the store 645 may be operable to provide access to code that is to be analyzed by one or more of the architectural components 610. Access as used herein may include reading, writing, deleting, updating, a combination including one or more of the above, and the like.

The code analyzer 615 is operable to analyze code to generate data that represents entities and interactions between the entities. Based on the teachings herein, this analysis may be done as will be understood by those skilled in the art.

The diagram generator 620 is operable to create diagrams such as the diagrams that have been described previously. In one embodiment, in conjunction with creating a diagram, the diagram generator may apply the pre-generation and post generation filters 635 and 625. In another embodiment, the pre-generation filter 635 may be applied by the code analyzer 615 when generating the data.

The diagram generator 620 may generate a diagram that includes graphical elements (e.g., such as boxes, lines, labels, other graphical elements, and the like) that represent the entities and interactions. The interactions may be illustrated in temporal order (e.g., in a sequence ordered by time). The diagram may include an indication (e.g., a graphical element indicating a link to) of an availability of another diagram that is reachable from the first diagram.

The user interface 630 may be operable to receive input that indicates an instruction to move between diagrams. For example, by clicking on a link or pressing a key, the user may instruct the navigator 640 to display a different diagram.

The post-generation filter 625 may be operable to collapse and expand one or more of the entities to generate another diagram as described previously.

The pre-generation filter 635 may be operable to remove interactions and/or entities from a diagram based on various criteria that has been described previously. The term “remove” used in this sense may include causing the code analyzer 615 to not generate data corresponding to the interactions and/or entities in the first place or collapsing, deleting, or skipping over such data that has already been generated.

The navigator 640 is operable to cause movement between diagrams and to create diagrams not yet created to which navigation is sought by interaction with other of the architectural components 610. When two diagrams are related by a link, data corresponding to the link may be stored to indicate the relationship. In addition, this data may be used for navigating between the two diagrams. In one embodiment, the function(s) of the navigator 640 may be distributed across other of the architectural components 610 and the navigator 640 may be omitted.

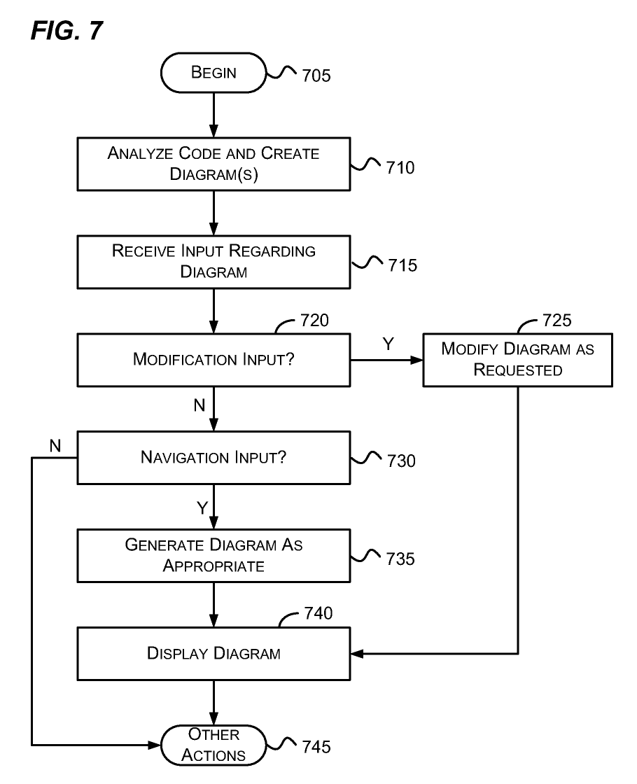

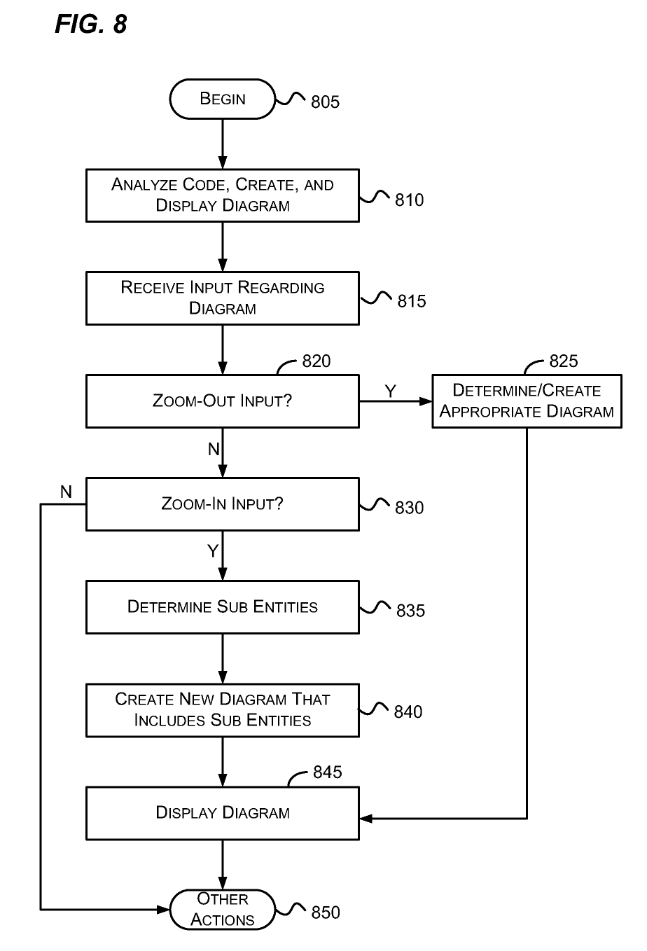

FIGS. 7-8 are flow diagrams that generally represent actions that may occur in accordance with aspects of the subject matter described herein. For simplicity of explanation, the methodology described in conjunction with FIGS. 7-8 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

Turning to FIG. 7, at block 705, the actions begin.

At block 710, code is analyzed and diagrams are created based thereon. For example, referring to FIG. 6, the code analyzer 615 may analyze code stored in the code store 645 and may generate data that represents entities and interactions between the entities of the code. Afterwards or in conjunction with generating the data, the diagram generator 620 may generate a diagram corresponding to the data.

At block 715, input regarding a diagram is received. For example, referring to FIG. 2, the user interface 630 may receive modification or navigation input from a user. As another example, heuristics may provide input that diagrams are to be modified.

At block 720, a determination is made as to whether the input is input to modify an existing diagram. If so, the actions continue at block 725; otherwise, the actions continue at block 730.

At block 725, the diagram is modified as requested. For example, referring to FIGS. 2, 4, and 6 if the user selects the message 210 of FIG. 2 and indicates that the message 210 and other messages are to be moved to another diagram. The diagram generator 620 may create the diagram 400 and associate the box 405 with the diagram 205 via the chunk reference 410. The user interface 630 may then display the diagram 400 to the user. To the user it appears that the entities and relationships have been moved to another diagram when in reality they may not have been moved (e.g., a new diagram may have been created). In a diagram that included more than just the entities 205-207 and the messages 210-217, the entities 205-207 and messages 210-217 may actually be moved (e.g., associated with) another diagram. Logically moving entities and relationships includes both actually and appearance-type movement. An exemplary diagram that results after logically moving the entities and messages to another diagram is the diagram 400 of FIG. 4.

As another example, if the user indicates that the entities on FIG. 2 are to be combined, a diagram similar to diagram 500 of FIG. 5 may result in which a graphical representation (a box) shows the combined entities and interactions between the entities are hidden.

As another example, if the user indicates that the collapsed entity 505 of FIG. 5 is to be expanded, the diagram 205 of FIG. 2 may result.

At block 730, a determination is made as to whether the input is input to navigate between diagrams. If so, the actions continue at block 735; otherwise, the actions continue at block 745.

At block 735, a diagram is generated as appropriate. For example, if the user selects to navigate to a diagram that has not yet been created, a new diagram may be generated. If the user selects to navigate to a diagram that has already been created, the diagram does not need to be re-created.

At block 740, the diagram is displayed. For example, referring to FIG. 6, the user interface 630 may display the new diagram (as modified or navigated to).

At block 745, other actions, if any, are performed.

Turning to FIG. 8, at block 805, the actions begin.

At block 810, code is analyzed and diagrams are created and displayed based thereon. For example, referring to FIG. 6, the code analyzer 615 may analyze code stored in the code store 645 and may generate data that represents entities and interactions between the entities of the code. The level of the entities (e.g., namespace, assembly, class, etc.) may be specified by a user, determined via context (e.g., what code the user is viewing when the user asks for a diagram), from a top-down approach where the broadest entities are displayed first, or the like. Afterwards or in conjunction with generating the data, the diagram generator 620 may generate a diagram corresponding to the data.

At block 815, input regarding a diagram is received. For example, referring to FIG. 2, the user interface 630 may receive a request to “drill down” into a particular entity.

At block 820, a determination is made as to whether the input is input to zoom-out from a particular diagram. If so, the actions continue at block 825; otherwise, the actions continue at block 830.

At block 825, if a diagram corresponding to the zoomed-out request has already been generated and is available, this diagram may be selected to display to the user. For example, if the user viewed a high level diagram, drilled in on a particular entity, and then zoomed-out, the diagram first shown to the user may be displayed again. If a diagram for the selected zoom level has not been previously generated, the diagram may be created at block 825.

At block 830, a determination is made as to whether the input is input to zoom-in on one or more entities of the diagram. If so, the actions continue at block 835; otherwise, the actions continue at block 850.

At block 835, sub entities are determined. For example, referring to FIG. 2, if the user selects a namespace entity (e.g., assume entity 205 is a namespace entity) and indicates a zoom-in operation, the assemblies of the namespace may be determined.

At block 840, a new diagram is created that includes the sub entities. For example, referring to FIG. 2, interactions between the assemblies included in the entity 205 may be determined. A new diagram may then be created using the assemblies and interactions between them.

At block 845, the selected or created diagram is then displayed. For example, referring to FIG. 6, the user interface 630 may display a zoomed-in or zoomed-out diagram based on user input.

At block 850, other actions, if any, are performed.

As can be seen from the foregoing detailed description, aspects have been described related to generating and using code-based diagrams. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
at least in part by analyzing code, generating first data that represents entities and interactions between the entities of the code;
generating second data that indicates a first set of entities and interactions to associate with a first diagram, a second set of entities and interactions to associate with a second diagram, and a point at which the first and second diagrams are associated, the first set of entities and the second set of entities being represented by the first data; and
displaying the first diagram together with an indication of availability of the second diagram, the first diagram illustrating the first set of entities and interactions.

2. The method of claim 1, further comprising receiving via a user interface an indication to associate the second set of entities and interactions with the second diagram.

3. The method of claim 2, further comprising in response to receiving via the user interface the indication, logically moving the second set of entities and interactions from a third diagram to the second diagram, the third diagram including the entities and interactions represented by the first data, the third diagram being displayed on the user interface just prior to receiving the indication.

4. The method of claim 1, further comprising applying a heuristic to determine whether to associate the second set of entities and interactions with the second diagram.

5. The method of claim 1, further comprising receiving, via a user interface, an indication to combine two or more of the entities and in response displaying a diagram that includes a graphical representation of the two or more entities and hiding interactions between the two or more of the entities.

6. The method of claim 1, further comprising receiving via a user interface an indication to expand one of the entities and in response displaying a diagram that includes entities included in the one of the entities together with any interactions between the entities included in the one of the entities.

7. The method of claim 1, wherein the interactions in the first set are illustrated in the first diagram in temporal order.

8. The method of claim 1, wherein the code includes one or more of source code, executable code, intermediate language code, data, resources, variables, definitions, and relationships.

9. The method of claim 1, wherein displaying the first diagram together with an indication of availability of the second diagram, comprises displaying a graphical element that when selected indicates that the second diagram is to be displayed.

10. The method of claim 1, wherein the entities include one or more of objects, namespaces, components, classes, and processes.

11. A computer storage medium having computer-executable instructions, which when executed perform actions, comprising:
at least in part by analyzing code, generating first data that represents entities and interactions between the entities of the code;
displaying a first diagram that indicates the entities and interactions between the entities.
receiving, via a user interface, input that indicates zooming in or out;
determining sub entities of one or more of the entities;
generating second data that represents interactions between the sub entities; and
displaying a second diagram that indicates the sub entities and the interactions between the sub entities.

12. The computer storage medium of claim 11, wherein the interactions comprise messages sent between the entities.

13. The computer storage medium of claim 11, wherein the first and second diagrams comprise sequence diagrams that indicate a temporal ordering of the interactions.

14. The computer storage medium of claim 11, wherein the entities comprise namespaces and wherein the sub entities comprise classes included in the one of the entities.

15. The computer storage medium of claim 11, further comprising receiving input that indicates one of the sub entities and in response generating third data the represents interactions between sub entities of the one of the sub entities.

16. The computer storage medium of claim 11, further comprising receiving, via the user interface, input that indicates that the sub entities are no longer to be displayed and in response displaying the first diagram again.

17. The computer storage medium of claim 11, wherein generating second data that represents interactions between the sub entities comprises generating the second data before receiving the input while displaying the first diagram.

18. In a computing environment, an apparatus, comprising:
a code store operable to provide access to code corresponding to one or more computer programs;
a code analyzer operable to analyze the code to generate data that represents entities and interactions between the entities of the code;
a diagram generator operable to create a first diagram from the data, the first diagram including graphical elements that represent the entities and the interactions between entities, the interactions being illustrated in temporal order, the first diagram including an indication of availability of a second diagram reachable from the first diagram, the second diagram representing other entities and interactions between the other entities; and
a user interface operable to receive input that indicates an instruction to move between the first diagram and the second diagram.

19. The apparatus of claim 18, further comprising a post-generation filter operable to collapse and expand one or more of the entities to generate a third diagram.

20. The apparatus of claim 18, further comprising a pre-generation filter operable to remove interactions and/or entities from a diagram based at least in part on a category of the interactions and/or entities.
